(19) United States
(12) Patent Application Publication
(10) Pub. No.: US 2018/0099441 A1
(43) Pub. Date: Apr. 12, 2018

(54) FEEDING APPARATUS

(71) Applicant: SHING FUH TAI TECHNOLOGY CORP., TAINAN CITY (TW)

(72) Inventors: Chia-Miao CHIU, Tainan City (TW); Kuo-Ming CHEN, Tainan City (TW); Kuong-Lam IP, Tainan City (TW)

(21) Appl. No.: 15/290,399

(22) Filed: Oct. 11, 2016

(51) Int. Cl. B29C 45/17; B29C 45/18

(52) U.S. Cl. CPC B29C 45/1701; B29C 2045/1875; B29C 45/18

(57) ABSTRACT

A feeding apparatus is mounted to an injection molding apparatus defining an injecting space for receiving multiple pellets, and includes a feeding device defining a feeding space that has a delivering space portion and a feeding space portion spatially intercommunicating the delivering space portion and the injecting space, a supplying device defining a supplying space spatially communicating with the delivering space portion and being operable to allow or interrupt spatial communication with the supplying space and the delivering space portion, and an air suction device mounted to the feeding device and being operable to draw air from the injecting space and the feeding space. The pellets move from the supplying device into the injecting space.

### FIELD

The disclosure relates to a feeding apparatus, and more particular to a feeding apparatus including an air suction device.

### BACKGROUND

Referring to FIG. 1, a conventional injection molding apparatus includes a main body 11, a barrel 12 that is disposed on the main body 11 and that extends horizontally, a hopper 13 that is disposed on and in spatial communication with the barrel 12, and a reciprocating screw 14 that is disposed in the barrel 12. The reciprocating screw 14 is rotatable in the barrel 12, and heats a plurality of plastic pellets received in the barrel 12. The hopper 13 receives a certain amount of the plastic pellets and feeds the plastic pellets into the barrel 12.

The plastic pellets tend to absorb environmental moisture, which may be evaporated during the process of melting and may be released from the plastic pellets to form water vapor. Such emission of water vapor may cause the barrel 12 to be overpressured and explode, and may cause an injected product to have voids, which would result in inferior mechanical properties. Thus, the plastic pellets are often heated and dried before being put into the hopper 13. An additional heating apparatus needs to be provided for heating the plastic pellets, leading to increased processing costs. Moreover, the plastic pellets need to be transferred from the heating apparatus into the injection molding apparatus, resulting in inconvenience and longer process time.

### SUMMARY

Therefore, an object of the present disclosure is to provide a feeding apparatus that can alleviate at least one of the drawbacks associated with the prior art.

According to the present disclosure, a feeding apparatus is adapted to be mounted to an injection molding apparatus defining an injecting space for receiving a plurality of plastic pellets to be heated in the injection space.

The feeding apparatus includes a feeding device, a supplying device, and an air suction device.

The feeding device is adapted to be mounted to the injection molding apparatus and defines a feeding space. The feeding space has a delivering space portion, and a feeding space portion that spatially intercommunicates the delivering space portion and the injecting space. The supplying device is mounted to the feeding device, defines a supplying space in spatial communication with the delivering space portion, and is operable to allow or interrupt spatial communication between the supplying space and the delivering space portion. The air suction device is mounted to the feeding device and is operable to draw air from the injecting space and the feeding space.

The plastic pellets move from the supplying device into the injecting space through a path including the supplying space, the delivering space portion and the feeding space portion.

### BRIEF DESCRIPTION OF THE DRAWINGS

Other features and advantages of the present disclosure will become apparent in the following detailed description of the embodiment with reference to the accompanying drawings, of which:

FIG. 1 is a partly sectional view of a conventional injection molding apparatus;

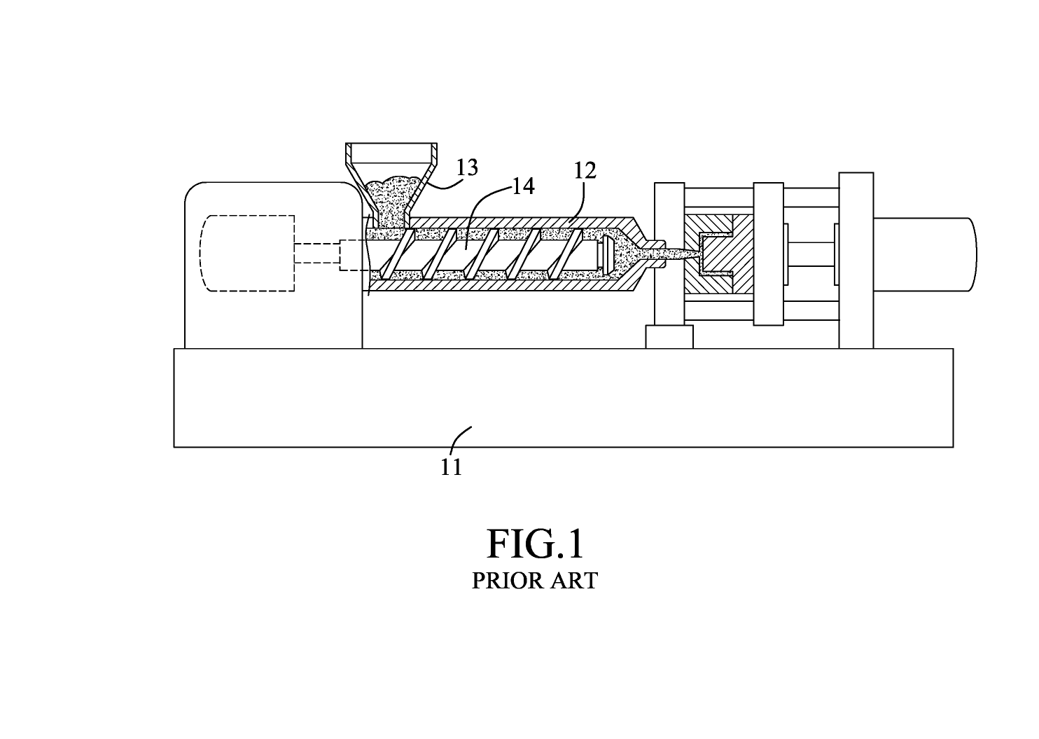

FIG. 2 is a partly exploded side view of an embodiment of a feeding apparatus according to the present disclosure, which is mounted to an injection molding apparatus;

FIG. 3 is a partly sectional view of the embodiment, showing a supplying valve of a supplying device being at a supplying position and a controlling unit of a feeding device being in a feeding state;

FIG. 4 is a side view of the embodiment;

FIG. 5 is a partly sectional view of the embodiment, showing the supplying valve being at a shutting position and the controlling unit being in the feeding state;

FIG. 6 is a partly sectional view of the embodiment, showing the supplying valve being at the shutting position and the controlling unit being in a discharging state; and

FIG. 7 is a partly sectional view of the embodiment, showing the supplying valve being at the shutting position and the controlling unit being in a shutting state.

### DETAILED DESCRIPTION

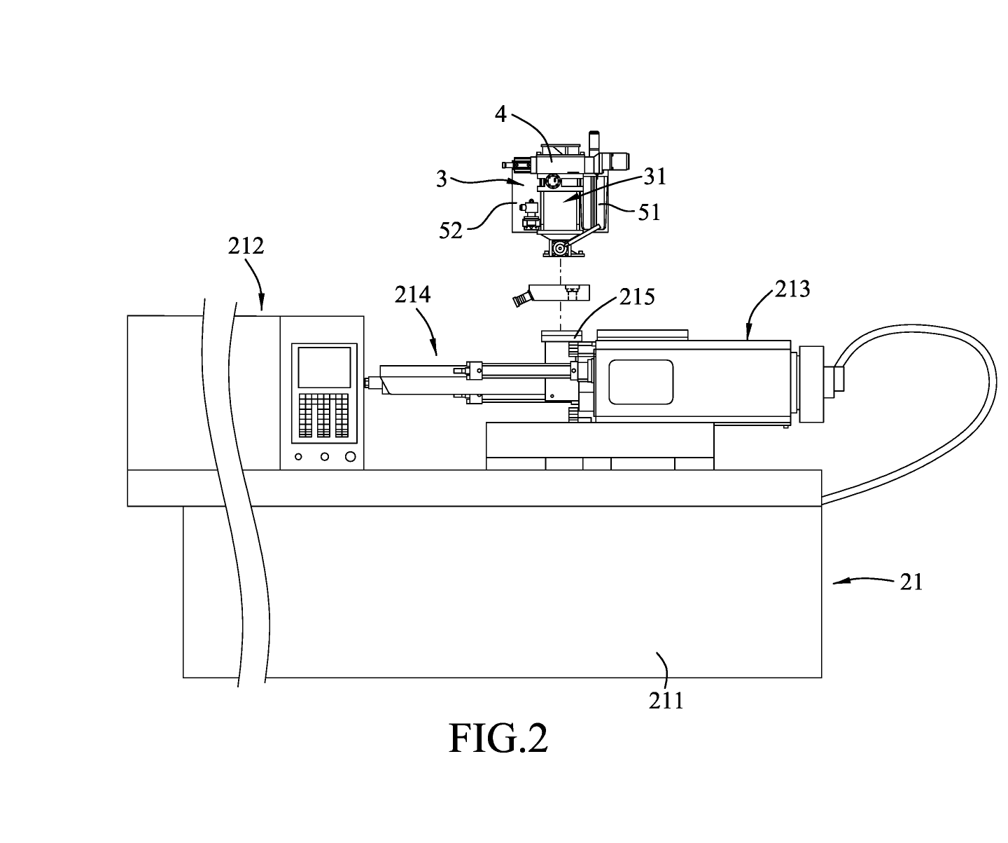

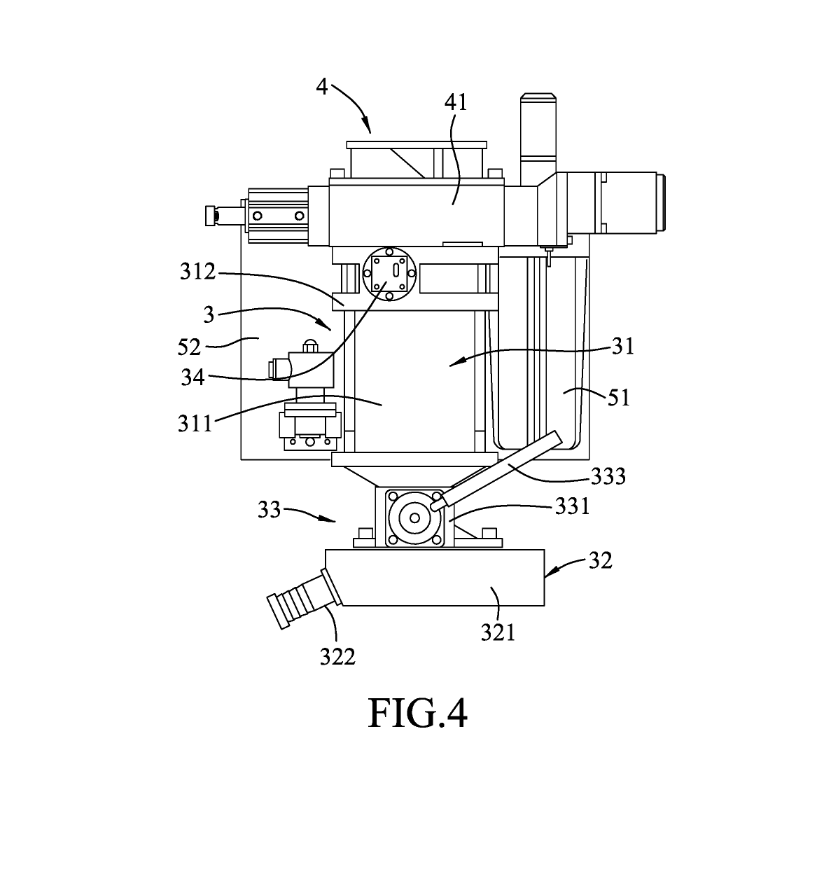

Referring to FIGS. 2 to 4, an embodiment of a feeding apparatus according to the present disclosure is adapted to be mounted to an injection molding apparatus 21 that heats and molds a plurality of plastic pellets (not shown) . The injection molding apparatus 21 includes a seat 211, a molding unit 212, an actuating unit 213, an injecting unit 214 and a loading seat 215. The molding unit 212 is disposed on the seat 211. The actuating unit 213 is disposed on the seat 211 and is spaced apart from the molding unit 212. The injecting unit 214 is connected between the molding unit 212 and the actuating unit 213. The loading seat 215 is disposed on and in spatial communication with the injecting unit 214. The injecting unit 214 cooperates with the loading seat 215 to define an injecting space 216 for receiving the plastic pellets to be heated in the injecting space 216.

The feeding apparatus includes a feeding device 3, a supplying device 4, an air suction device 51 and a controlling device 52.

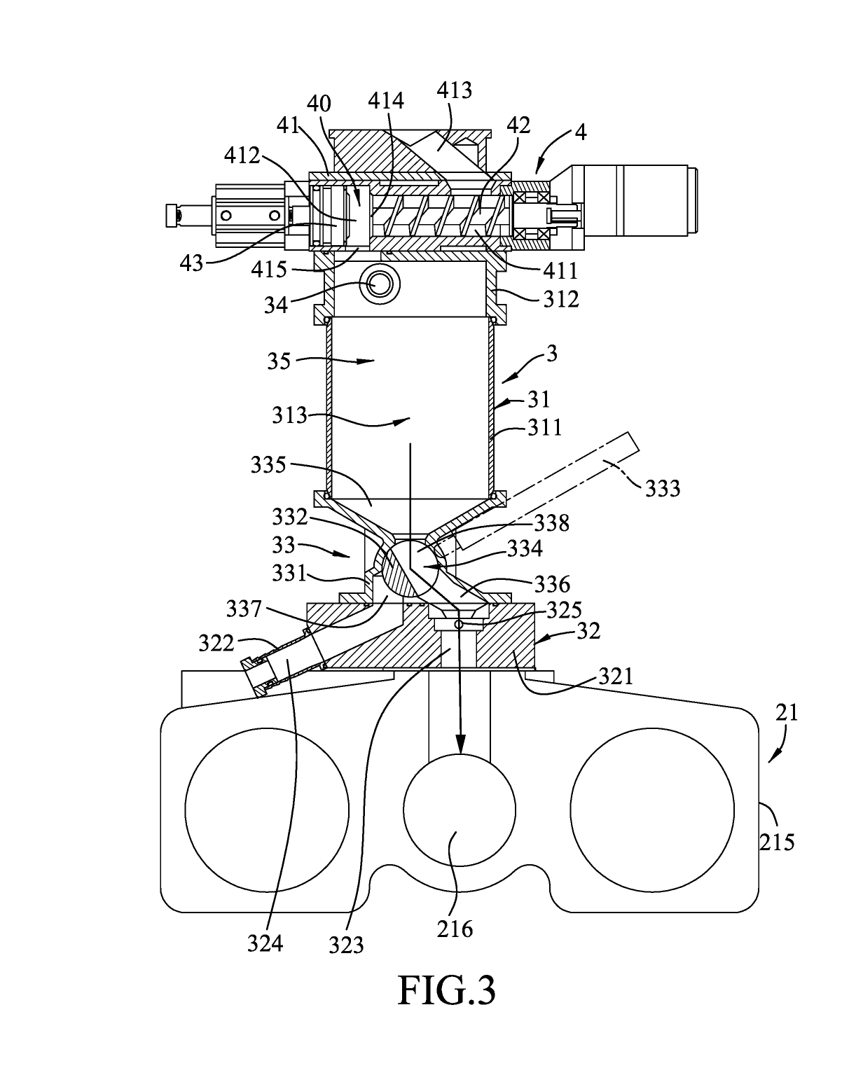

Referring to FIGS. 3 to 5, the feeding device 3 is adapted to be mounted to the injection molding apparatus 21 and defines a feeding space 35. The feeding space 35 has a delivering space portion 313, a feeding space portion 323 that spatially intercommunicates the delivering space portion 313 and the injecting space 216, and a discharging space portion 324 that is in spatial communication with the delivering space portion 313.

The feeding device 3 includes a feeding unit 31, a feeding-discharging unit 32, a controlling unit 33 and a sensing element 34.

The feeding unit 31 is mounted to the supplying device 4, defines the delivering space portion 313, and includes a connecting seat 312 and a feeding barrel 311. The containing seat 312 is mounted to the supplying device 4. The feeding barrel 311 is connected between the connecting seat 312 and the controlling unit 33. The feeding barrel 311 cooperates with the connecting seat 312 to define the delivering space portion 313. The connecting seat 312 may have a circular horizontal cross-section.

The feeding-discharging unit 32 is adapted to be mounted to a top surface of the loading seat 215 of the injection molding apparatus 21, and is spaced apart from the feeding unit 31. The feeding-discharging unit 32 includes a feeding seat 321 that is mounted to the top surface of the loading seat 215, and a discharging tube 322 that is fixedly connected to the feeding seat 321. The feeding seat 321 defines the feeding space portion 323 and an air suction space portion 325 that spatially intercommunicates the feeding space portion 323 and the air suction device 51. The discharging tube 322 cooperates with the feeding seat 321 to define the discharging space portion 324, which is spaced apart from the feeding space portion 323.

The controlling unit 33 is connected between the feeding unit 31 and the feeding-discharging unit 32, and includes a controlling seat 331, a controlling valve 332 and a handle 333. The controlling seat 331 is connected between the feeding barrel 311 of the feeding unit 31 and the feeding seat 321 of the feeding-discharging unit 32, and defines a controlling space portion 334. The controlling space portion 334 is substantially inverted Y-shaped, and has a connecting space segment 335, a feeding space segment 336, a discharging space segment 337 and a controlling space segment 338. The connecting space segment 335 is in spatial communication with the delivering space portion 313. The feeding space segment 336 is in spatial communication with the feeding space portion 323. The discharging space segment 337 is in spatial communication with the discharging space portion 324. The controlling space segment 338 spatially intercommunicates the connecting space segment 335, the feeding space segment 336 and the discharging space segment 337. The controlling valve 332 is received in the controlling space segment 338. The handle 333 is co-rotatably connected to the controlling valve 332, and is operable to convert the controlling unit 33 between a feeding state where spatial communication between the delivering space portion 313 and the discharging space portion 324 is interrupted and where spatial communication between the delivering space portion 313 and the feeding space portion 323 is allowed, and a discharging state where spatial communication between the delivering space portion 313 and the feeding space portion 323 is interrupted and where spatial communication between the delivering space portion 313 and the discharging space portion 324 is allowed.

In other words, the feeding space 35 has the delivering space portion 313, the feeding space portion 323, the discharging space portion 324, the air suction space portion 325 and the controlling space portion 334. Communication relationship among the space portions and segments is described above.

The sensing element 34 is disposed on the connecting seat 312 of the feeding unit 31 and is adapted for sensing storage amount of the plastic pellets in the feeding unit 31.

The supplying device 4 is mounted to the feeding device 3, defines a supplying space 40 that is in spatial communication with the delivering space portion 313, and is operable to allow or interrupt spatial communication between the supplying space 40 and the delivering space portion 313.

To be more specific, the supplying space 40 has a screw rod space portion 411, a supplying space portion 413 that spatially communicates with the screw rod space portion 411, and a valve space portion 412 that spatially intercommunicates the screw rod space portion 411 and the delivering space portion 313. The valve space portion 412 has a first opening 414 that spatially communicates with the screw rod space portion 411 and a second opening 415 that spatially communicates with the delivering space portion 313. The supplying device 4 includes a supplying seat 41, a supplying screw rod 42 and a supplying valve 43. The supplying seat 41 defines the screw rod space portion 411 and the valve space portion 412. The supplying screw rod 42 is received rotatably in the screw space portion 411 and is adapted to push the plastic pellets from the screw rod space portion 411 into the valve space portion 412. The supplying valve 43 is received in the valve space portion 412 and is operable to allow or interrupt spatial communication between the valve space portion 412 and the delivering space portion 313. When the spatial communication between the valve space portion 412 and the delivering space portion 313 is allowed, the supplying valve 43 is spaced apart from the first opening 414 and the second opening 415. On the other hand, when the spatial communication between the valve space portion 412 and the delivering space portion 313 is interrupted, the supplying valve 43 blocks the first opening 414 and the second opening 415.

The plastic pellets move from the supplying device 4 into the injecting space 216 through a path including the supplying space portion 413, the screw rod space portion 411, the valve space portion 412, the delivering space portion 313, the connecting space segment 335, the controlling space segment 338, the feeding space segment 336 and the feeding space portion 323.

The air suction device 51 is mounted to the feeding device 3 and is operable to draw air from the injecting space 216 and the feeding space 35. To be more specific, the air suction device 51 is operable to draw air from the injecting space 216 and the feeding space 35 via the air suction space portion 325. The controlling device 52 is operable by an user to actuate the supplying screw rod 42 and the supplying valve 43.

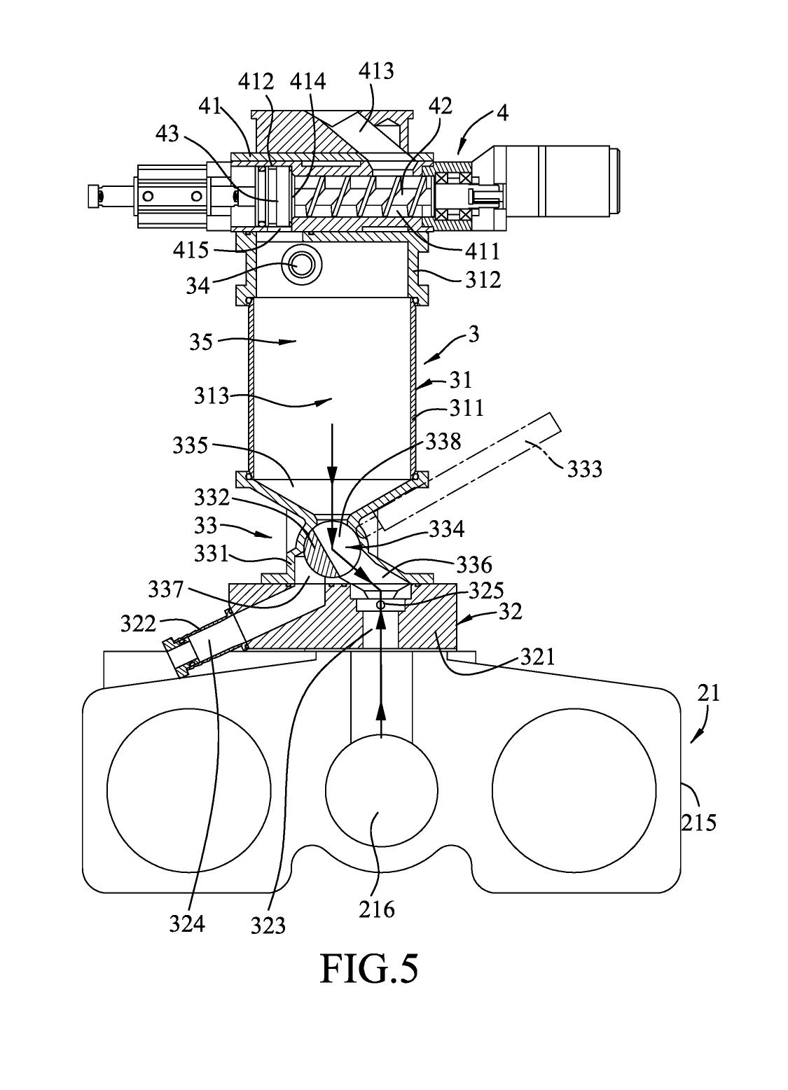

Referring to FIGS. 3 and 5, the supplying valve 43 is convertible between a supplying position (see FIG. 3) and a shutting position (see FIG. 5) . At the supplying position, the supplying valve 43 is spaced apart from the first opening 414 and the second opening 415. At the shutting position, the supplying valve 43 blocks the first opening 414 and the second opening 415 to prevent the pellets from entering the valve space portion 412 via the screw rod space portion 411, and to prevent gas that is released from the plastic pellets in the injecting space 216 from entering the valve space portion 412 via the delivering space portion 313.

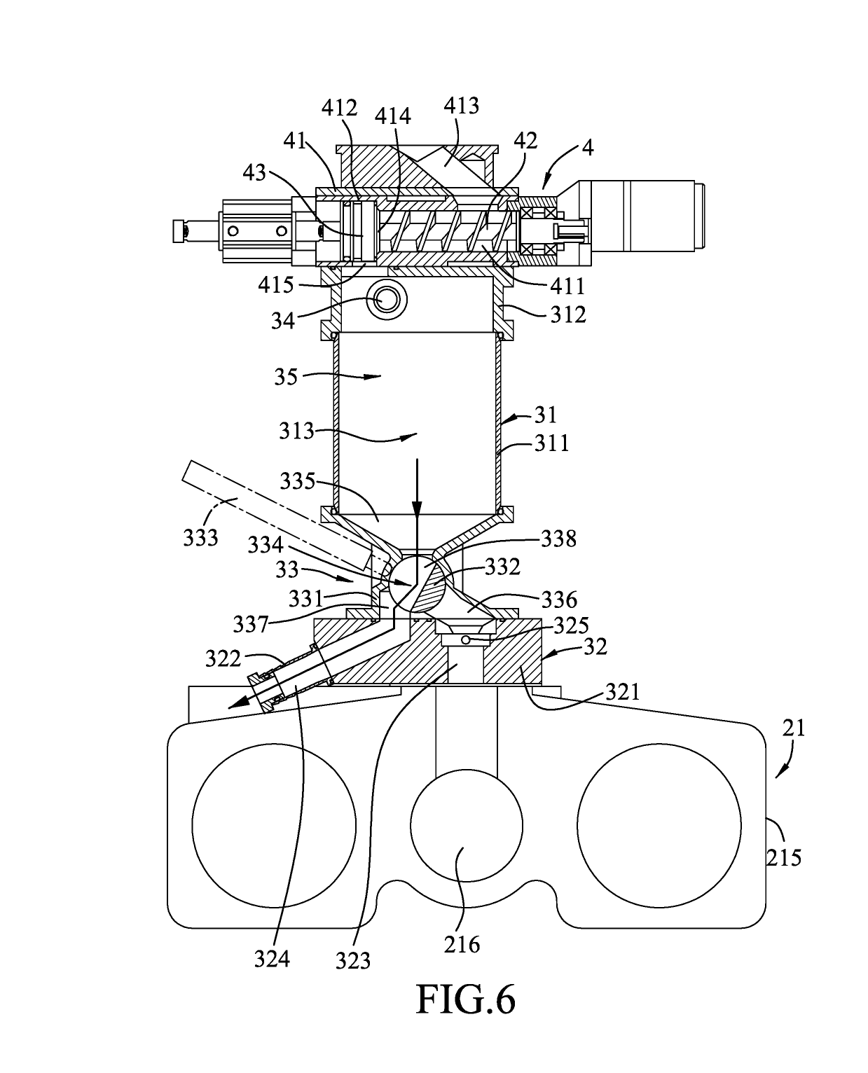

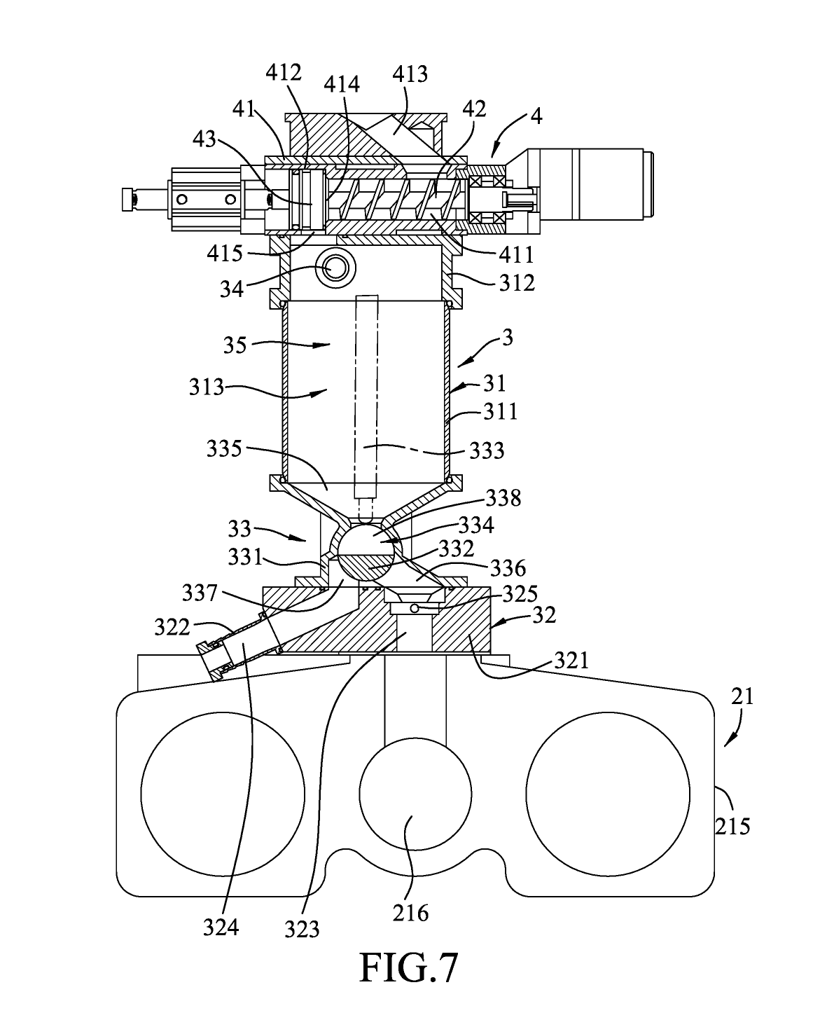

Referring to FIGS. 5 to 7, in this embodiment, the handle 333 is co-rotatably connected to the controlling valve 332, and is operable to convert the controlling unit 33 among the feeding state (see FIG. 5), the discharging state (see FIG. 6) and a shutting state (see FIG. 7). In the feeding state, the controlling valve 332 interrupts spatial communication between the discharging space segment 337 and the controlling space segment 338, and allows spatial communication between the feeding space segment 336 and the controlling space segment 338. In the discharging state, the controlling valve 332 interrupts spatial communication between the feeding space segment 336 and the controlling space segment 338, and allows spatial communication between the discharging space segment 337 and the controlling space segment 338. In the shutting state, the controlling valve 332 interrupts spatial communication among the feeding space segment 336, the discharging space segment 337 and the controlling space segment 338.

Referring to FIGS. 3 to 5, in the process of performing injection molding, the supplying valve 43 is rotated to the supplying position (see FIG. 3). The plastic pellets move from the supplying device 4 into the injecting space 216 through the path as describe above. Specifically, the plastic pellets are placed into the supplying space portion 413 and drops into the screw rod space portion 411, followed by being pushed by the supplying screw rod 42 to pass through the valve space portion 412 and enter the delivering space portion 313. When the plastic pellets are piled up from the injecting space 216 to the level of the sensing element 34, the sensing element 34 sends a sensing signal to the controlling device 52, and the controlling device 52 then sends a control signal such that the supplying screw rod 42 stops, the supplying valve 43 moves to the shutting position, and the air suction device 51 starts to operate.

When the plastic pellets are heated in the injecting space 216, moisture or organic solvent absorbed by the plastic pellets may be released in the form of gas. As indicated by the arrows in FIG. 5, when the air suction device 51 starts to operate, the gas in the feeding space 35 (i.e., the delivering space portion 313, the connecting space segment 335, the controlling space segment 338, the feeding space segment 336 and the feeding space portion 323) and the injecting space 216 is drawn by the air suction device 51 via the air suction space portion 325. It is worth mentioning that the gas may include particles that can also be drawn by the air suction device 51.

Referring to FIGS. 3, 6 and 7, after injection molding, the user may rotate the handle 333 to convert the controlling unit 33 to the discharging state (see FIG. 6) such that the surplus plastic pellets are discharged from the feeding barrel 311 via the discharging space segment 337. Then the user may rotate the handle 333 to convert the controlling unit 33 to the shutting state (see FIG. 7). In other embodiments, the discharging space segment 337 may be omitted, which would not affect the degas of the plastic pellets in the injecting space 216.

To sum up, the air suction device 51 can draw the gas that is released by the plastic pellets upon being heated. Moreover, the controlling unit 33 is convertible among the feeding state, discharging state and the shutting, and the supplying valve 43 is convertible between the supplying position and the shutting position, which both facilitate input and output of the plastic pellets.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A feeding apparatus adapted to be mounted to an injection molding apparatus that defines an injecting space for receiving a plurality of plastic pellets to be heated in the injecting space, said feeding apparatus comprising:
a feeding device that is adapted to be mounted to the injection molding apparatus and that defines a feeding space, said feeding space having a delivering space portion and a feeding space portion that spatially intercommunicates said delivering space portion and the injecting space;
a supplying device that is mounted to said feeding device, that defines a supplying space in spatial communication with said delivering space portion, and that is operable to allow or interrupt spatial communication between said supplying space and said delivering space portion; and
an air suction device that is mounted to said feeding device and that is operable to draw air from the injecting space and said feeding space,
wherein the plastic pellets move from said supplying device into the injecting space through a path including said supplying space, said delivering space portion and said feeding space portion.

2. The feeding apparatus as claimed in claim 1, wherein:
said supplying space has a screw rod space portion and a valve space portion that spatially intercommunicates said screw rod space portion and said delivering space portion; and
said supplying device includes
a supplying seat that defines said screw rod space portion and said valve space portion,
a supplying screw rod that is received rotatably in said screw rod space portion and that is adapted to push the plastic pellets from said screw rod space portion into said valve space portion, and
a supplying valve that is received in said valve space portion and that is operable to allow or interrupt spatial communication between said valve space portion and said delivering space portion.

3. The feeding apparatus as claimed in claim 1, wherein:
said feeding space further has a discharging space portion that is in spatial communication with said delivering space portion; and
said feeding device includes
a feeding unit that is mounted to said supplying device and that defines said delivering space portion,
a feeding-discharging unit that is adapted to be mounted to the injection molding apparatus, that defines said feeding space portion and said discharging space portion, and
a controlling unit that is connected between said feeding unit and said feeding-discharging unit, and that is convertible between a feeding state where spatial communication between said delivering space portion and said discharging space portion is interrupted and where spatial communication between said delivering space portion and said feeding space portion is allowed, and a discharging state where spatial communication between said delivering space portion and said feeding space portion is interrupted and where spatial communication between said delivering space portion and said discharging space portion is allowed.

4. The feeding apparatus as claimed in claim 3, wherein:
said feeding space further has an air suction space portion that is defined by said feeding-discharging unit and that is in spatial communication with said feeding space portion; and
said air suction device is operable to draw air from the injecting space and said feeding space via said air suction space portion.

5. The feeding apparatus as claimed in claim 3, wherein:
said feeding unit includes a connecting seat that is mounted to said supplying device, and a feeding barrel that is connected between said connecting seat and said controlling unit, said feeding barrel cooperating with said connecting seat to define said delivering space portion; and
said feeding device further includes a sensing element that is disposed on said connecting seat and that is adapted for sensing storage amount of the plastic pellets in said feeding unit.

6. The feeding apparatus as claimed in claim 3, wherein:
said feeding space further has a controlling space portion that spatially intercommunicates said delivering space portion, said feeding space portion and said discharging space portion, and that has a connecting space segment, a feeding space segment, a discharging space segment and a controlling space segment;
said connecting space segment is in spatial communication with said delivering space portion, said feeding space segment being in spatial communication with said feeding space portion, said discharging space segment being in spatial communication with said discharging space portion, said controlling space segment spatially intercommunicating said connecting space segment, said feeding space segment and said discharging space segment;
said controlling unit includes
a controlling seat that is connected between said feeding unit and said feeding-discharging unit, and that defines said controlling space portion,
a controlling valve that is received in said controlling space segment, and
a handle that is co-rotatably connected to said controlling valve, and that is operable to convert said controlling unit between the feeding state and the discharging state.
